(19) United States
(12) Patent Application Publication
(10) Pub. No.: US 2020/0220569 A1
(43) Pub. Date: Jul. 9, 2020

(54) PROTECTIVE CASE FOR MOBILE DEVICE

(71) Applicants: Esther IN, Germantown, MD (US); Stella IN, Germantown, MD (US); Sungyong In, Germantown, MD (US); Hyunjeung IN, Germantown, MD (US)

(72) Inventors: Esther IN, Germantown, MD (US); Stella IN, Germantown, MD (US); Sungyong In, Germantown, MD (US); Hyunjeung IN, Germantown, MD (US)

(21) Appl. No.: 16/628,023

(22) PCT Filed: Oct. 31, 2018
(86) PCT No.: PCT/US18/58599

§ 371 Date: Dec. 31, 2019

Related U.S. Application Data
(60) Provisional application No. 62/579,146, filed on Oct. 31, 2017.

(51) Int. Cl. H04B 1/3888; G06F 1/16

(52) U.S. Cl. CPC H04B 1/3888; G06F 1/1656; G06F 1/1626; G06F 1/1632

(57) ABSTRACT

By way of example, a protective case for a mobile device providing enhanced functionality of the mobile device is provided. The protective case may include: a body configured to receive and retain the mobile device; a plurality of slots disposed in the body, and each of the plurality of slots may be configured to receive a storage unit for expanding a capability of the mobile device; and a connection part disposed in the body and coupled to the plurality of slots. The connector part of the protective case may be configured to couple the plurality of storage units with the mobile device; and when the plurality of storage units is inserted in the plurality of slots in the body of the protective case for operation, a capability of the mobile device is enhanced.

### CROSS-REFERENCE TO RELATED APPLICATION(S)

The present application claims the benefit of U.S. Provisional Patent Application No. 62/579,146, filed Oct. 31, 2017, the entire content of which is incorporated by reference herein in its entirety.

### TECHNICAL FIELD

The present disclosure relates to an apparatus for providing protection of a mobile device as well as enhanced functionalities of the mobile device and in particular, to a protective case for the mobile device for enhanced functionalities of the mobile device.

### BACKGROUND

Mobile devices such as cellular phones, tablets, small computing devices, etc. are ubiquitous in people's lives nowadays. More applications are developed requiring more resources such as memory and/or processing power on mobile devices including cellular phones, tablets and etc. Each time new versions of operating systems and/or software applications are available, the new versions of the operating systems and/or software applications appear to require more memory for executing the new operating systems and/or software applications. Further, as mobile devices are ubiquitous in all aspects of our daily lives, new features or applications are being added requiring more resources on the mobile devices. For example, people take digital pictures using their mobile devices, replacing digital cameras. Also, a wider screen and high end computing processors or resources are needed for executing a variety of new functions on the mobile devices, thereby raising the price of new versions of the mobile devices

Further, as the mobile devices are expensive communication equipment, there is a need for protecting the mobile devices from accidental drop or fall, which causes cracks or damages to the mobile devices. Repairing damaged mobile devices are not always cheap and reasonable. Thus, many people purchase protective cases for their mobile devices. The protective cases are now becoming an additional device to purchase for a new mobile device for protection. However, the protective devices that are available in the marketplace just provide physical protection from accidental damages. The traditional protective cases for the mobile devices are made of thick plastic and/or rubber casings. The protective cases for the mobile devices are very simple types and are designed for protecting the mobile devices from accidental damages to the mobile devices. As such, there is a need for a new, innovative protective case for a mobile device that will enhance the features or capabilities of the mobile device.

### SUMMARY

The present technology described herein provides an apparatus for providing one or more enhanced capabilities of a mobile device via a protective case of a mobile device. That is, the present invention provides in an aspect a new, novel protective case for the mobile device which provides not only physical protection of the mobile device but also enhanced features or functionalities for the mobile device.

In one embodiment of the present technology, a protective case for a mobile device is provided. By way of example, the protective case may include: a body configured to receive and retain the mobile device; a plurality of slots disposed in the body, and each of the plurality of slots may be configured to receive a storage unit for expanding a capability of the mobile device; and a connection part disposed in the body and coupled to the plurality of slots. The connector part of the protective case may be configured to couple the plurality of storage units with the mobile device; and when the plurality of storage units is inserted in the plurality of slots in the body of the protective case for operation, a capability of the mobile device is enhanced.

In another aspect of the present disclosure, the protective case may further include a control unit configured to control and manage the plurality of storage units.

In an aspect of the present disclosure, the protective case may further include one or more enclosure doors for the plurality of slots disposed in the body, and the one or more enclosure doors are configured to securely retain the plurality of storage units in the plurality of slots disposed in the body.

In another aspect of the present disclosure, the control unit of the protective case may comprise circuitry or logic configured to control and manage access and/or storage of data in the plurality of storage units from the mobile device.

In another embodiment of the present technology, a protective case for a mobile device may include a body configured to receive and retain the mobile device; an expansion slot disposed in the body, the expansion slot being configured to receive a module for enhancing a capability of the mobile device; and a connector part disposed in the body, the connector part being configured to couple the expansion module to the mobile device for operation.

In an aspect of the present disclosure, the expansion module disposed in the expansion slot of the protective case may comprise a radio module, a rechargeable battery, a radiation detection device, or a location identifier module that is independent of GPS signals.

In another aspect of the present disclosure, the expansion module disposed in the protective case may be controlled via a graphical user interface (GUI) displayed on the mobile device.

In another aspect of the present disclosure, the protective case may further include a plurality of weights distributed over the protective case such that during a free fall of the protective case and the mobile device, the mobile device being enclosed in the protective case lands on ground in a predetermined manner.

In another aspect of the present disclosure, the weights comprise distributed weights on one or more corners of the protective case.

In another embodiment of the present technology, a protective case for a mobile device may include a body configured to receive and retain the mobile device; and a plurality of slots disposed in the body and configured for receiving a plurality of cartridges, each of which is configured to include a scent or perfume.

In an aspect of the present technology, the protective case may further include a plurality of weights distributed over one or more corners of the protective case such that during a free fall of the protective case and the mobile device, a combination of the protective case and the mobile device lands on ground in a predetermined manner to minimize an impact on the mobile device.

In an aspect of the present disclosure, the protective case may further include an optical lens integrated in the body of the protective case for a purpose of enhancing a camera function of the mobile device.

In another aspect of the present disclosure, the protective case may further include a slider configured to cover a camera lens of the mobile device.

In another aspect of the present disclosure, the protective case may further include a mirror disposed on the body of the protective case.

In another aspect of the present disclosure, the protective case may further include a magnifying glass disposed on the body, and the magnifying glass may be configured to deploy for use.

### BRIEF DESCRIPTION OF THE DRAWINGS

A more detailed understanding may be obtained from the following description in conjunction with the following accompanying drawings.

FIG. 1 is a diagram conceptually illustrating an example embodiment of the present technology in accordance with an aspect of the present disclosure;

FIG. 2 is a diagram conceptually illustrating an example embodiment of the present technology in accordance with an aspect of the present disclosure;

FIG. 3 is a diagram conceptually illustrating an example embodiment of the present technology in accordance with an aspect of the present disclosure;

FIG. 4 is a diagram conceptually illustrating an example embodiment of the present technology in accordance with an aspect of the present disclosure;

FIG. 5 is a diagram conceptually illustrating an example embodiment of the present technology in accordance with an aspect of the present disclosure;

FIGS. 6 and 7 illustrate example embodiments in accordance with an aspect of the present disclosure;

FIGS. 8A-8C illustrate example embodiments in accordance with an aspect of the present disclosure; and

FIG. 9 is a block diagram conceptually illustrating an example of an embodiment in accordance with an aspect of the present disclosure.

### DETAILED DESCRIPTION

The detailed description of illustrative examples will now be set forth below in connection with the various drawings. The description below is intended to be exemplary and in no way limit the scope of the claimed invention. It provides a detailed example of possible implementation(s), and is not intended to represent the only configuration in which the concepts described herein may be practiced. As such, the detailed description includes specific details for the purpose of providing a thorough understanding of various concepts, and it is noted that these concepts may be practiced without these specific details. In some instances, well known structures and components are shown in block diagram form in order to avoid obscuring such concepts. It should be noted that like reference numerals are used in the drawings to denote like elements and features.

While the methodologies are described herein sometimes as a series of steps or acts, for the purpose of simplicity it is to be understood that the claimed subject matter is not limited by the order of these steps or acts, as some steps or acts may occur in different orders and/or concurrently with other acts from that shown and described herein. Further, not all illustrated steps or acts may be required to implement various methodologies according to the present technology disclosed herein. Also, it should be appreciated that the apparatus and methods described herein may be utilized separately or in combination with other aspects of the present disclosure, or in combination with conventional technology, without departing from the teachings of the present disclosure.

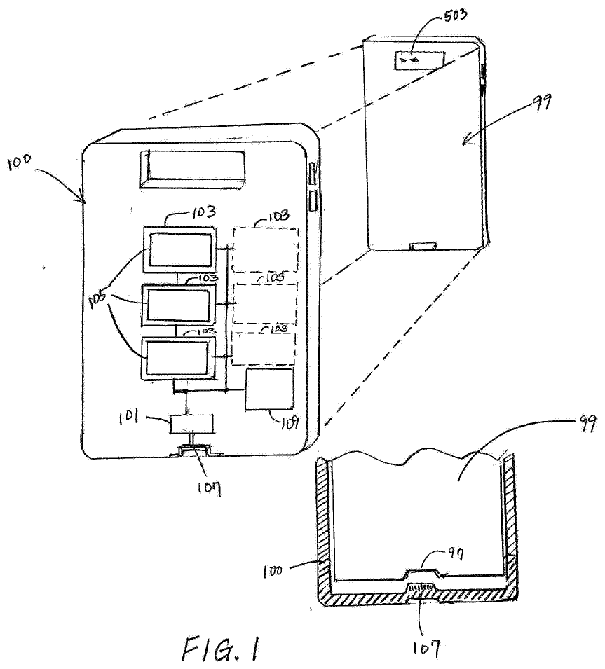

FIG. 1 illustrates an example embodiment of the present technology in accordance with an aspect of the present disclosure. By way of example, the protective case may include: a body configured to receive and retain the mobile device; a plurality of slots disposed in the body, and each of the plurality of slots may be configured to receive a storage unit for expanding a capability of the mobile device; and a connection part disposed in the body and coupled to the plurality of slots. The connector part of the protective case may be configured to couple the plurality of storage units with the mobile device; and when the plurality of storage units is inserted in the plurality of slots in the body of the protective case for operation, a capability of the mobile device is enhanced.

By way of example, FIG. 1 shows a protective case for a mobile device. A protective case 100 for a mobile device 99 (e.g., a cellular phone, a tablet, a computing device, a communication device, etc.) includes a body 101 configured to receive and retain the mobile device 99, a plurality of slots 103 disposed in the body 101, and a connection part 107 disposed in one end of the body 101. The plurality of slots 103 are configured to receive a plurality of storage units 105 for expanding a capability of the mobile device 99.

By way of example, the plurality of storage units 105 may include a plurality of memory devices such as, but not limited to, a random access memory, a flash memory, a solid state memory, or the like. In an aspect of the present disclosure, each storage unit or memory device may be a removable memory card, including a compact flash (CF) card, a secure digital (SD) card, a smart media (SM) card, a multimedia (MMC) card, a miniSD card, a micro SD card, a secure digital xtended capacity (SDXC) card, a secure digital high capacity (SDHC) card, or any other variants or memory expansion cards.

In the example, the connection part 107 is configured to couple the plurality of storage units 105 to the mobile device 99 for operation and usage. By way of example, the connection part 107 may include a docking connector disposed in the one end of the body 101 of the protective case 100, thereby establishing electrical connections between the mobile device 99 and various components of the protective case 100 including the plurality of storage units 105 and a controller 109. In an aspect of the present disclosure, when the mobile device 99 is inserted or enclosed in the protective case 100, the connection part 107 of the protective case 100 ‘docks-in with’ (or couples with) a docking connector 97 of the mobile device 99, thereby making electronic components disposed on the protective case 100 subsidiary components of the mobile device 100 under its control and management. In the example, the connection part 107 of the protective case 100 and the docking connector 97 of the mobile device 99 may form a matching pair of connectors for securing enabling electrical connections between the mobile device 99 and the protective case 100 for operation. In the present disclosure, the term “dock connector” or “docking connector” is used to refer to a connector or a receptacle used to attach a mobile electronic device to one or more external resources. By way of example, the dock connector including the connection part 107 and the docking connector 97 are configured to carry a variety of signals and power between the mobile device 99 and the protective case 100. For example, the docking connector 97 and the connection part 107 may be a pair of connectors configured to support Apple's 30-pin dock connection, lightning connection, or micro USB connection for Android devices. Further, the docking connectors 97 and the connection part 107 may be configured to carry USB, FireWire, audio outputs, video, and other control signals between the mobile device 99 and the protective case 100.

In an aspect of the present disclosure, the plurality of slots 105 disposed in the body 101 are configured to receive storage units and may be coupled to the connection part 107 via a connection interface 111, which supports various types of docking connections between the mobile device 99 and the protective case 100, and the controller 109. The controller 109 may be responsible for various functions including read or write operations into the plurality of storage units 105 by the mobile device 99 (e.g., by one or more applications or processes running on the mobile device 99). Further, the controller 109 is also configured to detect presence of a storage unit 105 in each slot 103, and perform its control and management functions of data to and from the plurality of storage units 105.

As such, for example, the plurality of slots 103 along with storage units 105 may be used to increase or expand a memory capacity of the mobile device 99, which is often limited by a manufacturer of the mobile device 99. Further, in the example, the plurality of slots 103 may be internally networked and/or electrically connected to each other so that a total storage capacity may be increased or decreased depending upon the number of memory cards or chips that are inserted in the plurality of slots 103 of the protective case 100. Also, as mentioned above, by way of example, the connector interface 111 and/or connector part 107 may be configured to couple to a dock connector of a mobile device such as a micro USB connector, a firewire connector, a lighting connector, a thunderbolt connector or any other proprietary connector of the mobile device, for control signals and data transfer between the mobile device and the protective case 100. Further, in one implementation, the controller 109 may be configured to perform security functions, such as standard encryption and/or decryption functions as well as other proprietary functions, for data that are stored in the plurality of storage units 105 disposed in the plurality of slots 103 of the protective case 100,

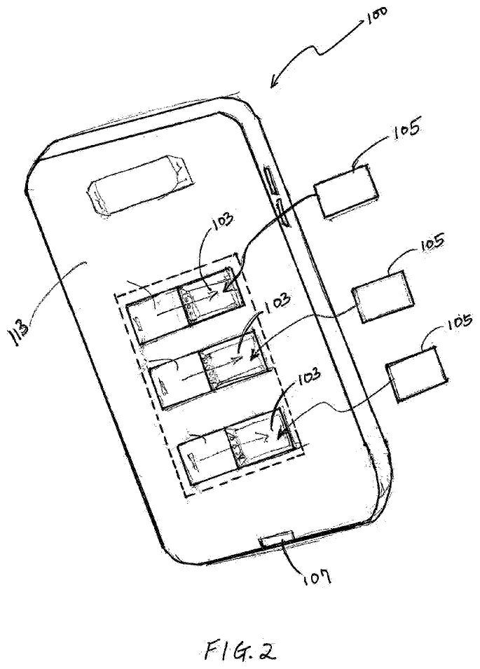

Furthermore, in an aspect of the present disclosure, the plurality of slots 103 may be in a modular form such that a desired capacity increase for the mobile device 99 may be configured. Also, the plurality of slots 103 may be designed in such a way that a removable memory or storage card or chip may be easily inserted or taken out. In another aspect of the present disclosure, as shown in FIGS. 1 and 2, the plurality of slots 103 may be covered by one or more enclosure doors that are configured to securely retain the plurality of storage units 105 in the plurality of slots 103 of the protective case 100. Also, each slot 103 may include a receiving recess for a storage unit and an enclosure door for secure installation and protection of the storage unit in the receiving recess. The enclosure door is designed in such a way that when closed it by the user it closes over the receiving recess and/or the storage unit installed in the receiving recess and locks, for example, by snap-in or other mechanisms.

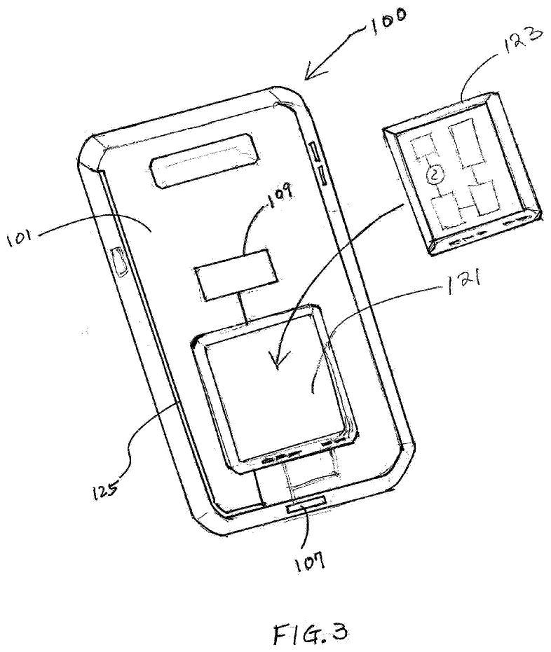

FIG. 3 illustrates another example embodiment of a protective case 100 for a mobile device in accordance with an aspect of the present disclosure. In the example, the protective case 100 includes a body 101 configured to receive and retain the mobile device, an expansion slot 121 disposed in the body 101 and configured to receive an expansion module 123, for enhancing functionalities of the mobile device. For example, a module 123 for enhancing a capability of the mobile device (e.g., an expansion module), and a connection part 107 disposed in a bottom end of the body 101. The connection part 107 is configured to couple to the expansion module 123 and the mobile device for an enhanced operation.

By way of example, in an aspect of the present disclosure, the expansion module 123 may include one or more of: a radio module (e.g., FM/AM radio), a rechargeable battery, a radiation detection device, a diagnostic or testing, a location identifier module that is not based on (or independent of) use of GPS signals, etc. or other enhanced function modules for the mobile device. In the example, the expansion module 123 may be a radio module including analog and digital circuitry to receive frequency modulated (FM) radio signals or amplitude modulated (AM) radio signals using an antenna 125 that is integrated in the protective case 100 for the mobile device. The signals may be received and sent to the mobile device for further processing, e.g., for signal processing of the signals for audio receptions. The expansion module 123 may also include analog/digital tuners as well as digitizers.

In another aspect of the present disclosure, the expansion module 123 may be controlled by one or more applications running on the mobile device or a graphical user interface (GUI) running on a mobile device such as the mobile device shown in FIG. 1. By way of example, for the purpose of tuning of the radio module installed in the expansion slot 121, a GUI may be installed and/or displayed on a user screen of the mobile device for control and management of the radio module for operation by a use of the mobile device.

In another aspect of the present disclosure, the expansion module 123 may be a rechargeable battery. The rechargeable battery may serve as another auxiliary battery for use for the mobile device. Further, in another aspect of the present disclosure, the rechargeable battery in the protective case 100 may work with and/or charged by various means of energy harvesting techniques that can be implemented in the protective case 100 or the mobile device. The rechargeable battery or the expansion module 123 may be controlled and managed by one or more applications or graphical user interfaces (GUIs) running on the mobile device. By way of example, by using one or more controls on a GUI on the mobile device, the use of the rechargeable battery in the expansion slot 121 of the protective case 100 may be turned on or off.

In another aspect of the present disclosure, the expansion module 123 may include a radiation detection device. By way of example, a small scale or modified version of a Geiger Counter with Geiger-Mueler Tube or Probe type radiation detector, or a digital radiation detector based on various sensors may be implemented in the expansion module 123. Alternatively, the expansion module 123 may include a test strip for radiation. In the example, the radiation detection module is configured to detect an amount of radiation in a given environment, such as gamma radiation, alpha and beta particles, in case of an emergency situation such as nuclear detonation, dirty bombs, etc. The radiation detection module or the expansion module 123 may be controlled and managed by one or more applications or GUIs running on the mobile device. For example, the expansion module processes data relating to the radiation detected and send them to the mobile device for display to a user of the mobile device via the one or more applications or GUIs. Further, in another aspect of the present disclosure, the one or more applications or GUIs running on the mobile device may present information relating to radiation exposure and recommended actions for the user of the mobile device to take. Furthermore, data such as the information relating to the detected radiation may be sent wirelessly to a central control location for further processing of the detected radiation levels. This feature is useful in a situation where emergency personnel are deployed in a certain area such as an alleged radiation exposure area.

In another aspect of the present disclosure, the expansion module 123 may include one or more enhanced functions for the mobile device. By way of example, in case of performing encryption or decryption operations on certain data that are received by or transmitted by the mobile device, such security functions or other processing functions may be performed by the expansion module 123 disposed in the expansion slot 121 of the protective case 100.

In another aspect of the present disclosure, the expansion module 123 may include a location identifier module which may include copies of digital maps of a region or a country, as well as certain circuitry or software to identify a current location of the mobile device without using global positioning system (GPS) signals. In certain situations the GPS signals may not be available, but a user of the mobile device may desire to know or use a location based service. As such, when the GPS signals are not available and/or cellular towers are not readily available in an area, the location identifier module is configured to provide location guidance to the user of the mobile device. For example, the location identified module may use last known location information of the mobile device, cellular or wireless signals, and/or other physical landmark information and others, for example, to provide proximate location information of the mobile device.

In another aspect of the present disclosure, the expansion module 123 may provide other enhanced features or functions to the mobile device that may be limited in functions and/or processing. A number of new user desired functions or features may be added to the mobile device via the expansion module 123 that are disposed in the expansion slot 121 of the protective case, thereby providing a new level of flexibility and enhanced capability to the mobile device.

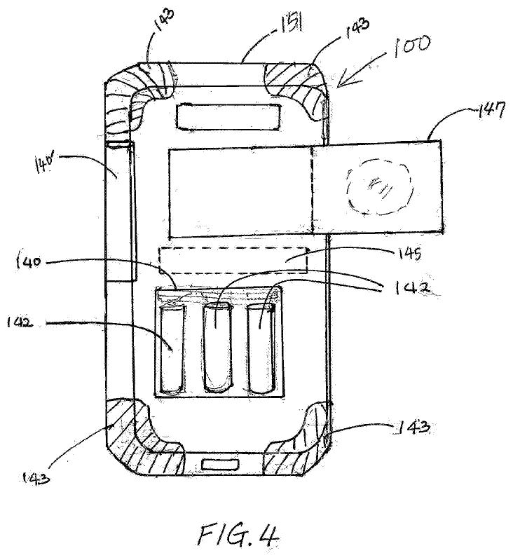

FIG. 4 illustrates another embodiment of the present technology in accordance with an aspect of the present disclosure. In one aspect of the present disclosure, a protective case 100 may include a cartridge compartment 140 for accommodating a plurality of cartridges of scent or perfume 142. A cartridge of scent or perfume 142 may be a removable cartridge containing a scent or perfume and may be inserted into one of the cartridge compartments 140 that are disposed on a back of the protective case 100. Alternatively, a cartridge compartment 140′ may be disposed on a top or a side of the protective case 100 for ease access and use. As such, a person who desires to wear a scent or perfume of choice may insert a cartridge of the scent or perfume in the protective case 100 and immediately use it when needed, which provides a great convenience to the users who carry their mobile devices in a protective case 100 in accordance with the present disclosure. Further, the protective case 100 may optionally include a slot or a respectable 145 for a lipbam or a lipstick.

In another aspect of the present disclosure, the protective case 100 may include one or more weights distributed over the protective case 100 for the purpose of changing a center of gravity of the combination of the mobile device and the protective case 100 such that when it drops it lands on ground in a predetermined manner. By way of example, the weights may be distributed on one or more corners of the protective case 100 in such a way that when the mobile device with the protective case 100 falls on the ground, it lands on the ground on its corner and bound back and lay on the ground in a safe manner. In another aspect of the present disclosure, such corner portions of the protective case 100 may include a shock absorption material including rubbers, polymer, composites, or other materials, which are designed to absorb the impact during the free fall and hit protect so that any damage the mobile device due to the impact is minimized via the protective case 100.

In another aspect of the present disclosure, the protective case 100 may include a mirror on the back of the protective case 100 for use by the user of the mobile device. Further, in another aspect of the present disclosure, the protective case 100 may include a magnifying class or a lens for people with a limited vision to view prints and/or other materials, or for those who want to use a magnifying glass similar to an old fashioned magnifying glass for viewing purposes. The magnifying glass may be configured and disposed in such a way that when it is not in use, it may be stored in a storage area of the protective case 100, and when the user desires to use it, it can be protracted or pulled out from the storage area for the viewing purposes.

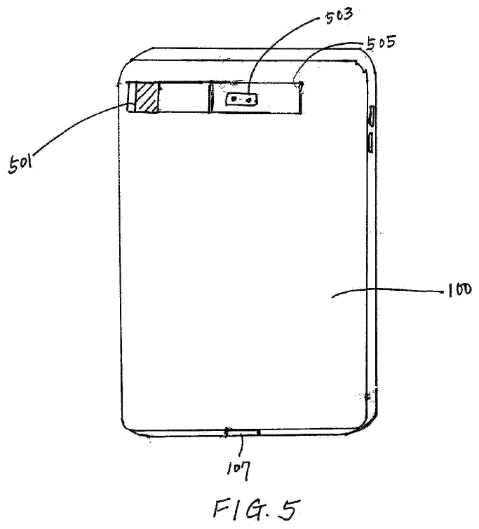

In another aspect of the present disclosure, FIG. 5 illustrates another example embodiment of the present technology. That is, in an aspect of the present disclosure, the protective case 100 may include a slider 501 for closing a cover for, e.g., a camera lens 503 of a mobile device 99 in the protective case 100 when the camera lens 503 of the mobile device is not in use. The slider 501 may be configured to control the cover for the camera lens 503, like a camera of the mobile device 99. Also, the cover may slide over the camera lens 503 of the mobile device to prevent scratches or damages. Further, the slider 501 may be slid to open or close the cover for the camera lens 503 of the mobile device 99. Furthermore, in another aspect of the present disclosure, the slider 501 or the cover for the camera lens 503 may be electrically connected to the mobile device 99 via the connector interface of the protective case 100 to automatically detect an operation of a camera application of the mobile device 99 and open the cover without a manual operation.

In another aspect of the present disclosure, the protective case 100 may include an additional lens integrated into the protective case 100 for close-up or other enhanced camera functions for the mobile device 99. By way of example, the additional lens may be configured to be attachable to the protective case 100 in an area 505 in front of the camera lens 503 of the mobile device 99. This additional feature may replace a need for having a clip-on type lens for a distance picture taking or the like. The user can insert the additional lens module into the area 505 disposed in the protective case 100. Alternatively, in an aspect of the present disclosure, the additional lens module (not shown) may be integrated into the protective case 100.

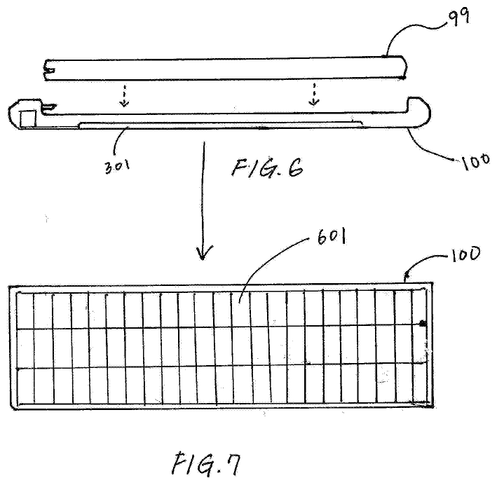

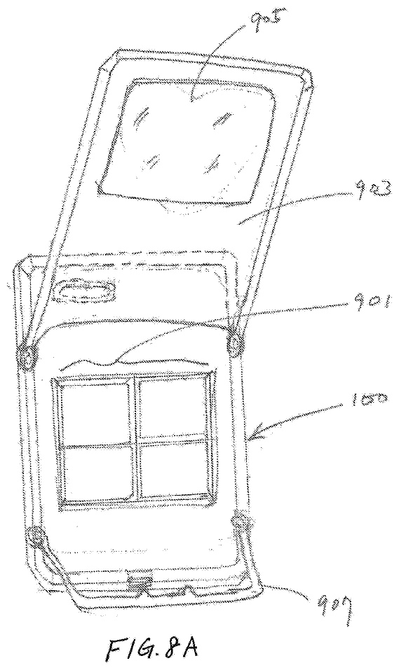

FIG. 6 provides another embodiment of the present technology in accordance with an aspect of the present disclosure. FIG. 6 is a diagram conceptually illustrating an example of an inductive charging system implemented in the protective case 100 in accordance with an aspect of the present disclosure. In the example, the protective case 100 may include an inductive charging pad 301 with circuitry to charge an on-board battery of the mobile device 99. Thus, in addition to charging of the mobile device 100 through the connector part 107, the mobile device 99 may be alternatively charged via the inductive charging pad 301 in the protective case 100. The inductive charging pad 301 may also be optimally designed to work with various types of commonly used charging pads. Also, the protective case 100 may include one or more controls so that the inductive charging pad 301 works with other standards or proprietary inductive charging systems for convenience of users. Alternatively, the protective case 100 may provide other types of energy harvesting interfaces such as solar energy. For example, the protective case 100 may include solar cells on a bottom surface of the protective case 100 to collect solar energy, as shown in FIG. 7. The solar energy collected by the solar cells may be converted or harvested into electricity for various uses. Further, the harvested electricity may be stored in a device or a storage included in the protective case 100 for later use, and for example, the harvested energy may be used to recharge a battery of the mobile device 99 via the connector part 107. Also, alternatively, the protective case 100 may be used with a larger solar panel to harvest a larger amount of solar energy and convert them into electricity.

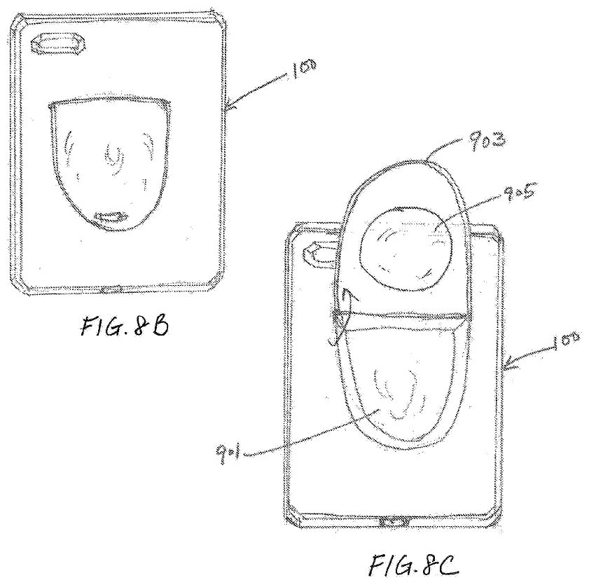

FIGS. 8A-8C illustrate example embodiments of the present technology in accordance with an aspect of the present disclosure. As shown in FIG. 8A, the protective case 100 includes a make-up compartment for use by ladies. For example, in one implementation, the protective cover 100 may include a cover 903 for the make-up compartment, make-up kits 901, a reflective mirror or the like 905, and a storage latch 907 for locking up the make-up compartment. In other implementations, the protective cover 100 may also include a different type of a make-up compartment with a mirror 905 and a make-up kit 901. It may be in the form of a flip-flop type of a compartment for the make-up kit. Further, other different types of compartments may be implemented in the protective case 100. Alternatively, in an aspect of the present disclosure, the make-up compartment may be removable and thus one can easily remove and replace with another make-up compartment for use. The make-up compartment may be latched-in or snapped-in into the back of the protective case 100.

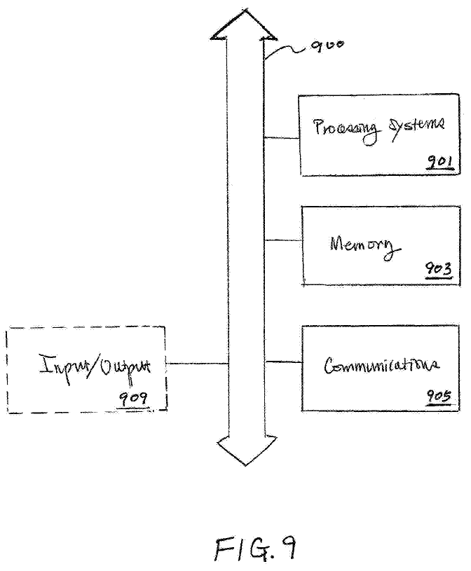

FIG. 9 illustrates an example diagram conceptually illustrating an apparatus for various functions, e.g., control and monitoring functions or unit or circuitry, for the protective case 100. By way of example, various components including the controller 109, the expansion module 123, the charging pad 301, and other components may be implemented using an example embodiment shown in FIG. 9. As shown in FIG. 9, a bus 900 may link together various circuits, including one or more processing systems (or processors) 901, one or more memories 903, one or more communication interfaces 905, and/or one or more input/output devices 909. The one or more processing systems may be responsible for managing the bus and general processing, including the execution of software stored on a non-transitory computer-readable medium. Further, the one or more processing systems may include one or more processors, such as microprocessors that interpret and execute instructions. In other implementations, the one or more processing systems may be implemented as or include one or more application specific integrated circuits, field programmable logic arrays, or the like. The software, when executed by the one or more processing systems, may cause the one or more processing systems to perform the various functions described herein for any particular apparatus. The non-transitory computer-readable medium may also be used for storing data that is manipulated by the one or more processing systems when executing software. The one or more memories may include various types of memories, including a random access memory and/or a read only memory, and/or other types of magnetic or optical recording medium and its corresponding device for storing information and/or instructions and/or retrieval thereof. The one or more communication interfaces may also include any transceiver-like mechanism that enables communication with other devices and/or systems. The one or more input/output devices may include devices that permit inputting information and/or outputting information to an operator.

Even though particular combinations of features are disclosed in the specification and/or recited in the claims, these combinations are not intended to limit the disclosure of the present technology. Further, the methods or methodologies for the present technology disclosed herein may be implemented in software, hardware, any combinations of software and hardware, a computer program or firmware incorporated in a computer readable medium for execution by a controller, a processor, a computer, or a processing system that includes one or more processors. Examples of processors include microcontrollers, microprocessors, digital signal processors (DSPs), discrete hardware circuits, gated logic, state machines, programmable logic devices (PLDs), field programmable gate arrays (FPGAs), and other suitable hardware configured to perform various functions described herein. The term “software” as used herein is to be construed broadly to mean any instructions, instruction sets, programs, subprograms, code, program code, software modules, applications, software packages, routines, objects, executables, threads of execution, procedures, functions, etc. including firmware, microcode, middleware, software, hardware description language, or the like.

Also, the term “software” as used herein includes various types of machine instructions including instructions, code, programs, subprograms, software modules, applications, software packages, routines, subroutines, executables, procedures, functions, etc. The software may also refer to general software, firmware, middleware, microcode, hardware description language, or etc. As noted above, the software may be stored on a computer-readable medium.

Examples of a computer-readable medium may include a non-transitory computer-readable medium, such as, by way of example, an optical disk, a magnetic storage device, a digital versatile disk, a flash memory, random access memory (RAM), read only memory (ROM), a register, programmable ROM (PROM), erasable PROM (EPROM), electrically erasable PROM (EEPROM), a removable disk, a flash memory device, and any other suitable medium for storing software that may be accessed and read by a processor or a processing system. It is also appreciated that one skilled in the art will recognize how best to implement the described functionality relating to adding new system functionalities to an existing network element, depending upon a particular application within design constraints.

The term “unit” or “component” as used herein means software, hardware, or any combinations thereof. A unit may be implemented as a software component, a hardware component, or any combinations thereof, including a field programmable gate array (FPGA), logic, logic arrays, application specific integrated circuit (ASIC), digital signal processor (DSP), microcontroller, microprocessor, etc. or any combinations thereof. The unit thus may include software components, task components, processes, procedures, functions, program code, firmware, micro-codes, circuits, data structures, tables, arrays, and variables.

While, for the purpose of simplicity, the methodologies are described herein as a series of steps or acts, it is to be understood that the claimed subject matter is not limited by the order of steps or acts, as some steps or acts may occur in different orders and/or concurrently with other acts from that shown and described herein. Further, not all illustrated steps or acts may be required to implement various methodologies according to the present technology disclosed herein. Furthermore, the methodologies disclosed herein and throughout this specification are capable of being stored on an article of manufacture to facilitate transporting and transferring such methodologies to one or more processing systems.

The term “article of manufacture” is intended to encompass a computer program accessible from any computer-readable device, carrier, or medium. A singular form may include a plural form if there is no clearly opposite meaning in the context. Also, as used herein, the article “a” is intended to include one or more items. Further, no element, act, step, or instruction used in the present disclosure should be construed as critical or essential to the present disclosure unless explicitly described as such in the present disclosure.

As used herein, except explicitly noted otherwise, the term “comprise” and variations of the term, such as “comprising,” “comprises,” and “comprised” are not intended to exclude other additives, components, integers or steps. The terms “first,” “second,” and so forth used herein may be used to describe various components, but the components are not limited by the above terms. The above terms are used only to discriminate one component from other components, without departing from the scope of the present disclosure.

Also, the term “and/or” as used herein includes a combination of a plurality of associated items or any item of the plurality of associated items. Further, it is noted that when it is described that an element is “coupled” or “connected” to another element, the element may be directly coupled or directly connected to the other element, or the element may be coupled or connected to the other element through a third element. Also, the term “in” may include “in” and “on”.

In the present disclosure, the term “include” or “have” as used herein indicates that a feature, an operation, a component, a step, a number, a part or any combination thereof described herein is present. Further, the term “include” or “have” does not exclude a possibility of presence or addition of one or more other features, operations, components, steps, numbers, parts or combinations.

Although the present technology has been illustrated with specific examples described herein for purposes of describing example embodiments, it is appreciated by one skilled in the relevant art that a wide variety of alternate and/or equivalent implementations may be substituted for the specific examples shown and described without departing from the scope of the present disclosure. As such, the present disclosure is intended to cover any adaptations or variations of the examples and/or embodiments shown and described herein, without departing from the spirit and the technical scope of the present disclosure.

1-9. (canceled)

10. A protective case for a mobile device, the protective case comprising:
a body configured to receive and retain the mobile device; and
a plurality of slots disposed in the body and configured for receiving a plurality of cartridges, wherein each cartridge is configured to include a scent or perfume.

11. The protective case of claim 10, further comprising a plurality of weights distributed over one or more corners of the protective case such that during a free fall of the protective case and the mobile device, a combination of the protective case and the mobile device lands on ground in a predetermined manner to minimize an impact on the mobile device.

12. The protective case of claim 10, further comprising an optical lens integrated in the body of the protective case for a purpose of enhancing a camera function of the mobile device.

13. The protective case of claim 12, further comprising a slider configured to cover a camera lens of the mobile device.

14. The protective case of claim 10, further comprising a mirror disposed on the body of the protective case.

15. The protective case of claim 10, further comprising a magnifying glass disposed on the body, wherein the magnifying glass is configured to deploy for use.
